(19) United States
(12) Patent Application Publication
(10) Pub. No.: US 2025/0085023 A1
(43) Pub. Date: Mar. 13, 2025

(54) HOT WATER TANK ASSEMBLY

(71) Applicant: COWAY Co., Ltd., Gongju-si (KR)

(72) Inventor: Jae Man KIM, Gongju-si (KR)

(73) Assignee: COWAY Co., Ltd., Gongju-si (KR)

(21) Appl. No.: 18/808,161

(22) Filed: Aug. 19, 2024

(30) Foreign Application Priority Data
Sep. 13, 2023 (KR) 10-2023-0122086

(51) Int. Cl. F24H 9/1818; F24H 9/13

(52) U.S. Cl. CPC F24H 9/1818; F24H 9/133

(57) ABSTRACT

A hot water tank assembly is disclosed. A hot water tank assembly according to one aspect of the present disclosure includes a hot water tank and a heating heater, the heating heater includes a plurality of straight lines, bent lines, and a connection line, and at least one intersecting portion, in which the straight line, the bent line, or the connection line intersects any one line of the straight line, the bent line, and the connection line, which are parallel and adjacent to each other, at an alternate angle, may be formed.

### CROSS-REFERENCE TO RELATED APPLICATION

This application claims priority to and the benefit of Korean Patent Application No. 10-2023-0122086, filed on Sep. 13, 2023, the disclosure of which is incorporated herein by reference in its entirety.

### BACKGROUND

### 1. Technical Field

The present event relates to a hot water tank assembly, and more specifically, to a hot water tank assembly including a heating heater with minimal interference between heater lines.

### 2. Discussion of Related Art

In general, water purifiers, water heaters, bidets, boilers, and the like include hot water tanks for storing high-temperature purified water to supply the high-temperature purified water to users.

As an example of a water purifier, such a hot water tank includes a water inlet pipe and a water outlet pipe which communicate with an accommodation space, and room-temperature purified water filtered through one or more filters is introduced into and stored in the accommodation space through a purified water tank and the water inlet pipe.

In addition, the room-temperature purified water stored in the accommodation space is heated to a set temperature by a heating heater included in the hot water tank, and the heated purified water is discharged so that a user can drink or use the water at a higher temperature than room temperature.

Meanwhile, as an example of such a heating heater for heating room-temperature purified water in a hot water tank, Japan Laid-Open Patent No. 2020-026943 is proposed. In a heating heater included in such the conventional hot water tank, a heater structure in which heater lines are disposed in multiple rows and are bent several times in an accommodation space of a hot water tank having a quadrangular box shape and the heater lines are connected in series is proposed.

Meanwhile, current water purifiers are becoming more compact, and a hot water tank including a heating heater is developed to have a structure with improved heating efficiency while reducing interference with other components (modules) constituting the water purifier.

However, an accommodation space of the hot water tank is limited, and as the miniaturization is progressed, a heating heater in multiple rows is inevitably disposed in a box with a small width, and accordingly, the heating heater inevitably has a structure in which a gap between the heater lines decreases and which is close to a wall surface of the hot water tank.

As described above, the gap between the heater lines (for example, a first row heater line and a second row heater line) constituting the heating heater in multiple rows decreases inevitably, and thus there is a problem that the heater lines disposed to face each other and interfere with each other while heating purified water to excessively generate bubbles and superheated steam is generated.

In addition, as the gap between the heater lines decreases, a gap between the heating heater and the wall surface also decreases, and thus there is a risk that soot is generated on the wall surface of the hot water tank, and there is a problem that boiling sound increases to generate noise due to the generation of the bubbles and the superheated steam.

Meanwhile, the current water purifiers are becoming more compact and also improve heating efficiency using the heating heater by increasing power consumed by the hot water tank. To this end, a structure in which power of the hot water tank is changed, for example, from 300 W to 500 W or from 300 W to 800 W is applied.

As described above, due to an increase in power of the hot water tank, the heater lines in the heating heater, which are close to and face each other, inevitably excessively generate more bubbles (boiling bubbles) and a large amount of superheated steam (over heating).

In addition, as described above, there was a problem that the overheated superheated steam are transferred to the purified water tank through a flow path, and heat of the superheated steam is transferred to the purified water tank to increase a temperature of stored room-temperature purified water.

Although the room-temperature purified water in the purified water tank is provided as high-temperature purified water through the hot water tank assembly, since the room-temperature purified water may be provided as low-temperature purified water through a low-temperature tank assembly or as ice in a solid state through an ice making module, when a temperature in the purified water tank increases to be out of a controllable range, there are problems of degrading overall purified water efficiency of the water purifier and increasing unnecessary power consumption.

Accordingly, the development of a hot water tank assembly including a heating heater, which prevents generation of bubbles and superheated steam due to overheating and in which interference between heater lines is minimized, is urgently required even the trends of the miniaturization and an increase in power.

### SUMMARY

The present disclosure is directed to providing a hot water tank assembly having a structure in which an intersecting portion is formed between heater lines constituting a heating heater in a hot water tank with a small width so that interference between the adjacent heater lines is minimal and an overheating amount and an amount of generated boiling bubbles are reduced.

In addition, the present disclosure is directed to providing a hot water tank assembly in which an intersecting portion between heater lines constituting a heating heater is minimized to induce reduction of an overheating amount to suppress a temperature increase of a purified water tank.

In addition, the present disclosure is directed to providing a hot water tank assembly in which an intersecting portion between heater lines constituting a heating heater is minimized, an area in which room-temperature purified water is in contact with the heating heater increases in a hot water tank, and the purified water is uniformly heated.

The objectives of the present disclosure are not limited to the above-described objectives, and other objectives that are not described can be clearly understood by those skilled in the art belonging to the present disclosure from the following description.

According to one aspect of the present disclosure, a hot water tank assembly is provided.

The hot water tank assembly includes a hot water tank in which an accommodation space is formed to store purified water so that the purified water is introduced through a water inlet pipe and discharged through a water outlet pipe and which includes a first heating terminal part and a second heating terminal part at one side thereof and a heating heater connected to the first heating terminal part and the second heating terminal part and disposed in multiple rows in the accommodation space to heat the purified water,

In this case, the heating heater includes a plurality of straight lines disposed in multiple rows to be parallel to each other in the accommodation space, a plurality of bent lines each having a set radius (R) value and connecting the straight lines disposed in the same row, and a connection line connecting the straight lines or the bent lines disposed in different rows. In addition, at least one intersecting portion, in which the straight line, the bent line, or the connection line intersects any one line of the straight line, the bent line, and the connection line, which are parallel and adjacent to each other, at an alternate angle, is formed.

Meanwhile, the heating heater of a first example may include a first row heater line including at least one of the straight lines and at least one of the bent lines and connected to the first heating terminal part, a second row heater line including at least one of the straight lines and at least one of the bent lines, connected to the second heating terminal part, and disposed parallel to the first row heater line, and a bent connection line connecting the first row heater line and the second row heater line and formed to be bent at the set R value.

As a more specific example, a virtual dividing line which divides the accommodation space into a first space and a second space may be formed.

In this case, the first row heater line may include a first straight line connected to the first heating terminal part and extending from the second space to the first space, a first bent line formed by bending the first straight line to have the set R value in a third direction in the first space, and a second straight line formed by extending the first bent line at an angle in the third direction from the first space to the second space, and connected to the bent connection line.

In this case, the second row heater line may include a third straight line formed by extending the bent connection line from the second space to the first space to be parallel to the first straight line without overlapping or intersecting the first straight line, a second bent line which is formed by bending the third straight line to have the set R value in the third direction in the first space, and forms a first intersecting portion with the first row heater line, a fourth straight line which is formed by extending the second bent line at an angle in the third direction from the first space to the second space, forms a second intersecting portion with the first row heater line, and forms a third intersecting portion with the bent connection line, and an extension line connecting the fourth straight line and the second heating terminal part.

Meanwhile, the extension line may be formed by bending the fourth straight line several times to have the set R value, is connected to the second heating terminal part, and forms a fourth intersecting portion with the first row heater line.

Meanwhile, each of the first bent line, the second bent line, and the bent connection line may have the set R value and an arc having a semicircular shape.

Meanwhile, a heating heater of a second example may include a first′ row heater line including at least one of the straight lines and the bent lines and connected to the first heating terminal part, a second′ row heater line including at least one of the straight lines and the bent lines and disposed parallel to the first′ row heater line, a third′ row heater line disposed parallel to the second′ row heater line, including at least one of the straight lines and the bent lines, and connected to the second heating terminal part, a first connection line connecting the first′ row heater line and the second′ row heater line, and a second connection line connecting the second′ row heater line and the third′ row heater line.

In this case, the first connection line and the second connection line may include straight lines having set lengths and may be disposed in parallel.

As a more specific example, a virtual dividing line which divides the accommodation space into a first space and a second space may be formed.

In this case, the first′ row heater line may include a first′ straight line of which one end portion is connected to the first heating terminal part and which has a length in the third direction and is disposed in the first space, a first′ bent line formed by bending the first′ straight line to have a set R′ value in a first direction, a second′ straight line formed by extending the first′ bent line at an angle in the third direction from the first space to the second space, and a second′ bent line formed by bending the second′ straight line to have the set R′ value in the third direction in the second space and connected to the first connection line in the second space.

In this case, the second′ row heater line may include a third′ bent line which is formed by bending the first connection line to have a set R′ value in the third direction in the first space and forms a first′ intersecting portion with the first′ row heater line, a third′ straight line which is formed by extending the third′ bent line from the first space to the second space and forms a second′ intersecting portion with the first′ heater line, and a fourth′ bent line formed by bending the third′ straight line to have the set R′ value in the third direction in the second space and connected to the second connection line in the second space.

In this case, the third′ row heater line may include a fifth′ bent line which is formed by bending the second connection line to have the set R′ value in the third direction in the first space, forms a third′ intersecting portion with the first′ row heater line, and forms a fourth′ intersecting portion with the second′ row heater line, a fourth′ straight line which is formed by extending the fifth′ bent line at an angle in the third direction from the first space to the second space, and forms a fifth′ intersecting portion with the first′ row heater line, a sixth′ bent line which is formed by bending the fourth′ straight line to have the set R′ value in the third direction in the second space and forms a sixth′ intersecting portion with the first′ row heater line, and a fifth′ straight line which is formed by extending the sixth′ bent line to have a length in the third direction in the second space such that one end portion of the fifth′ straight line is connected to the second heating terminal part, and forms a seventh′ intersecting portion with the second′ row heater line.

Meanwhile, each of the first′ bent line and the sixth′ bent line may have the set R′ value and form an arc having a ¼ circular shape.

Meanwhile, each of the second′ bent line, the third′ bent line, the fourth′ bent line, and the fifth′ bent line may have the set R′ value and form an arc having a semicircular shape.

Meanwhile, the first heating terminal part and the second heating terminal part may be disposed on the same outer surface of the hot water tank and have a gap therebetween.

Meanwhile, as an example, the hot water tank may be formed in a quadrangular box shape.

In this case, in the water outlet pipe, a water outlet port may be formed above a highest height of the heating heater.

In this case, the hot water tank may include a temperature sensor disposed above a highest height of the heating heater.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating an exterior of a hot water tank assembly according to one embodiment of the present disclosure;

FIG. 2 is a view illustrating a first example of a heating heater in two rows applied to the hot water tank assembly according to one embodiment of the present disclosure;

FIG. 3 is a view illustrating the heating heater of the first example according to FIG. 2 separated from the hot water tank;

FIG. 4 is a bottom view illustrating the heating heater of the first example according to FIG. 3 in a third direction;

FIG. 5 is a front view illustrating the heating heater of the first example according to FIG. 3 in a first direction;

FIG. 6 is a view illustrating a second example of the heating heater in three rows applied to the hot water tank assembly according to one embodiment of the present disclosure;

FIG. 7 is a view illustrating the heating heater of the second example according to FIG. 6 separated from the hot water tank in a second direction from one side;

FIG. 8 is a view illustrating the heating heater of the second example according to FIG. 6 separated from the hot water tank in the second direction from the other side;

FIG. 9 is a top view illustrating the heating heater of the second example according to FIG. 7 in a third direction;

FIG. 10 is a bottom view illustrating the heating heater of the second example according to FIG. 7 in the third direction; and

FIG. 11 is a front view illustrating the heating heater of the second example according to FIG. 7 in the first direction.

### DETAILED DESCRIPTION OF EXEMPLARY EMBODIMENTS

Hereinafter, various embodiments of the present disclosure will be described in detail with reference to the accompanying drawings in order for those skilled in the art to easily perform the present disclosure. The present disclosure may be implemented in several different forms and is not limited to the embodiments described herein. Parts irrelevant to description are omitted in the drawings in order to clearly describe the present disclosure, and the same or similar parts are denoted by the same reference numerals throughout this specification.

Terms and words used in this specification and claims should not be interpreted as limited to commonly used meanings or meanings in dictionaries and should be interpreted with meanings and concepts which are consistent with the technological spirit of the present disclosure based on the principle that the inventors have appropriately defined concepts of terms in order to describe the disclosure in the best way.

Therefore, since the embodiments described in this specification and configurations illustrated in the drawings are only exemplary embodiments and do not represent the overall technological spirit of the disclosure, the corresponding configurations may have various equivalents and modifications that can substitute for the configurations at the time of filing of the present disclosure.

It should be understood that the terms “comprise,” “include,” and the like herein specify the presence of stated features, numbers, operations, elements, components, or combinations thereof but do not preclude the presence or addition of one or more other features, numbers, operations, elements, components, or combinations thereof.

Unless there are special circumstances, a case in which a first component is disposed “in front of,” “behind,” “above,” or “under” a second component includes not only a case in which the first component is disposed directly “in front of,” “behind,” “above,” or “under” the second component, but also a case in which a third component is interposed therebetween. Unless there are special circumstances, a case in which a first component is connected to a second component includes not only a case in which the first component is directly connected to the second component, but also a case in which the first component is indirectly connected to the second component.

Hereinafter, an X-axis direction, a Y-axis direction, and a Z-axis direction mean a direction parallel to an X-axis, a direction parallel to a Y-axis, and a direction parallel to a Z-axis illustrated in the drawings, respectively. In addition, unless there are other descriptions, the X-axis direction has a concept including both positive and negative directions, and this is equally applied to the Y-axis direction and the Z-axis direction.

Meanwhile, in the description, the X-axis direction will be referred to as a first direction, the Y-axis direction will be referred to as a second direction, and the Z-axis direction will be referred to as a third direction, but these are only exemplary according to a relative aspect, the first direction to the third direction and coordinate axes (X, Y, and Z-axes) are only adopted to describe relative locations between components and do not limit absolute locations of the components.

In addition, when the present disclosure is described, detailed descriptions of related well-known functions or components will be omitted to prevent the gist of the disclosure from being ambiguously described.

Hereinafter, a hot water tank assembly according to one embodiment of the present disclosure will be described with reference to the accompanying drawings.

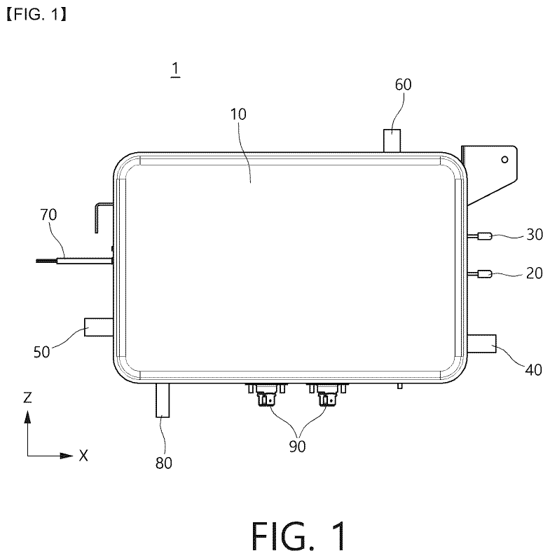

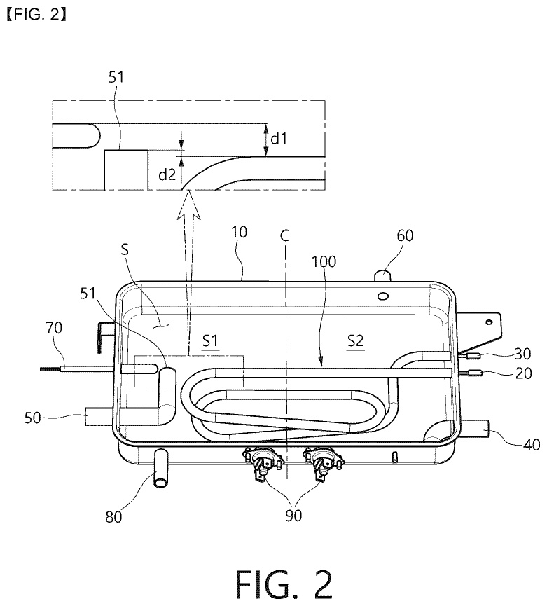

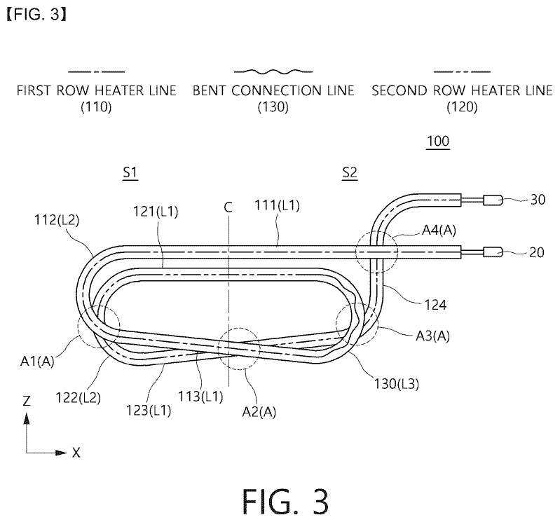

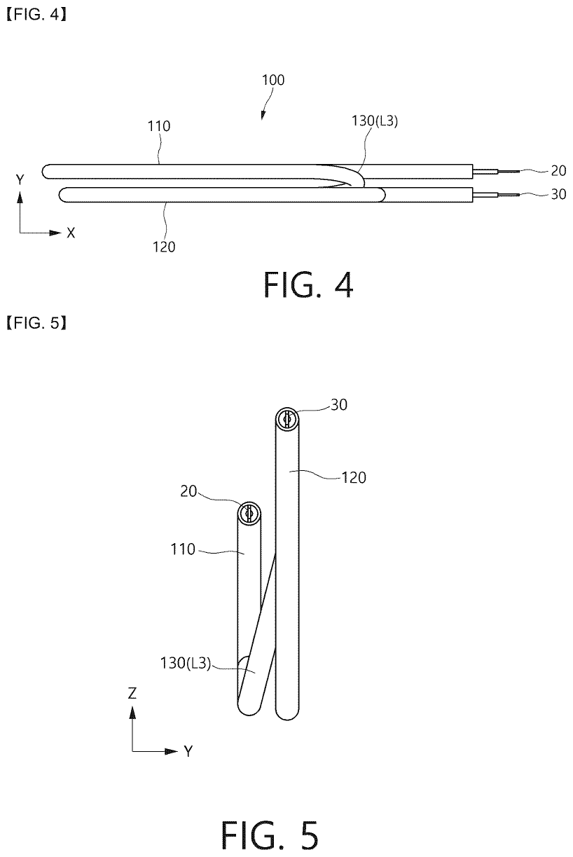

FIG. 1 is a view illustrating an exterior of a hot water tank assembly according to one embodiment of the present disclosure, and FIG. 2 is a view illustrating a first example of a heating heater applied to the hot water tank assembly according to one embodiment of the present disclosure. FIG. 3 is a view illustrating the heating heater of the first example according to FIG. 2 separated from the hot water tank, and FIG. 4 is a bottom view illustrating the heating heater of the first example according to FIG. 3 in a third direction. FIG. 5 is a front view illustrating the heating heater of the first example according to FIG. 3 in a first direction.

As illustrated in the drawings, a hot water tank assembly 1 according to one embodiment of the present disclosure is disposed to have a structure in which portions of heater lines 110 and 120 in multiple rows constituting a heating heater 100 in an accommodation space S of a hot water tank 10 and facing each other are reduced and one or more intersecting portions A in which the heater lines 110 and 120 intersect each other at an alternate angle. Accordingly, interference between the heater lines 110 and 120 disposed in adjacent rows is minimal, and amounts of overheating and generated boiling bubbles are reduced.

To this end, the hot water tank assembly 1 according to one embodiment of the present disclosure mainly includes the hot water tank 10 and the heating heater 100 having the intersecting portion A in the accommodation space S of the hot water tank 10 and disposed in multiple rows to heat room-temperature purified water into high-temperature purified water having a set temperature.

As an example, the hot water tank 10 has a quadrangular box shape having the accommodation space S.

In addition, the hot water tank 10 may include a water inlet pipe 40, a water outlet pipe 50, an air-drain pipe 60, a temperature sensor 70, a drain pipe 80, and a bimetal 90.

The hot water tank 10 having the quadrangular box shape may improve spatial efficiency by reducing interference with other components (modules) constituting a water purifier according to the trend of miniaturization of the water purifier. In other words, a dead space region may be reduced, and the other components may be easily disposed in a housing of the water purifier.

However, in the embodiment of the present disclosure, the hot water tank 10 is not limited to the quadrangular box shape, and as long as the miniaturization of the water purifier can be implemented, a circular or oval structure may be applied to the hot water tank 10 as necessary.

However, in the embodiment of the present disclosure, it is proposed that the hot water tank 10 is formed in the quadrangular shape in which a width of the hot water tank 10 in a second direction is smaller than a length of the hot water tank 10 in the first direction, and it is proposed that the heating heater 100 in multiple rows is disposed in a shape to be optimized in the accommodation space S of the hot water tank 10 having the small width.

However, the shape of the heating heater 100 applied to the embodiment of the present disclosure may also be applied to a shape of the hot water tank, such as a circular or oval shape, as necessary.

Meanwhile, the hot water tank 10 may have a structure in which a wall surface includes a heat insulating material to store high-temperature purified water heated by the heating heater 100 or a structure in which a wall surface includes a vacuum insulating space (not shown) in a vacuum state, of which a pressure is lower than an atmospheric pressure, as necessary.

Since a technology and a structure already known for the hot water tank 10 constituting the water purifier may be applied to the structure for the heat insulation of the hot water tank 10 and the structure including the water inlet pipe 40, the water outlet pipe 50, the air-drain pipe 60, the temperature sensor 70, the drain pipe 80, and the bimetal 90, the detailed descriptions thereof will be omitted to prevent the gist of the present disclosure from being ambiguously described.

However, the hot water tank 10 constituting the hot water tank assembly 1 according to one embodiment of the present disclosure has the accommodation space S which stores purified water introduced through the water inlet pipe 40 and discharged through the water outlet pipe 50. In addition, the hot water tank 10 includes a first heating terminal part 20 and a second heating terminal part 30 disposed at one side to be electrically connected to the heating heater 100.

In addition, the heating heater 100 electrically connected to the first heating terminal part 20 and the second heating terminal part 30 and disposed in multiple rows to heat room-temperature purified water is disposed in the accommodation space S of the hot water tank 10.

In this case, the heating heater 100 has a structure with minimal interference between the adjacent heater lines 110 and 120 and reduced amounts of overheating and generated boiling bubbles.

To this end, the heating heater 100 includes a plurality of straight lines L1, a plurality of bent lines L2, and a connection line L3.

First, each of the straight lines L1 constituting the heating heater 100 have a straight line shape, which is not bent, and the plurality of straight lines L1 have a structure to be disposed parallel to each other in multiple rows in the accommodation space S of the hot water tank 10.

In addition, each of the bent lines L2 is a bent line having a set radius (R) value and has a structure disposed to connect the adjacent straight lines L1 disposed in the same row.

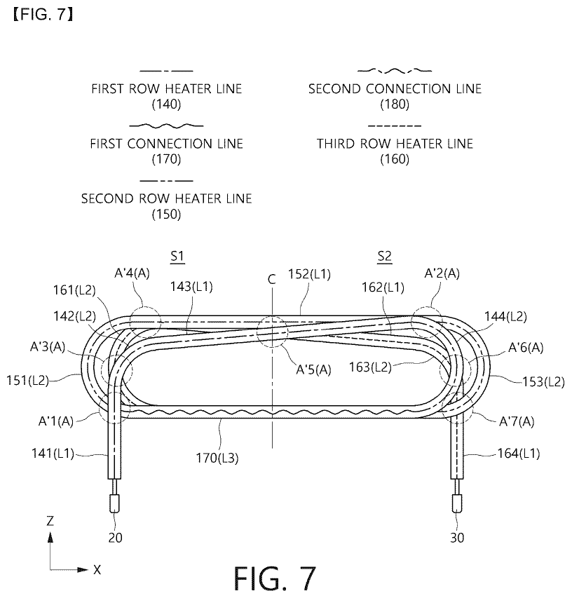

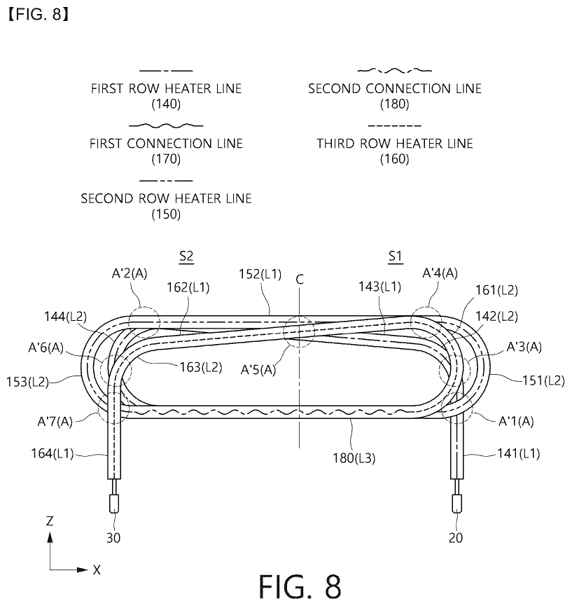

Meanwhile, the connection line L3 is a line connecting the straight lines L1 or the bent lines L2 which are disposed in the different rows and, as necessary, may have the set R value like the bent line L2 and a bent line shape, for example, a bent connection line 130 (see FIG. 3) of the first example, or a straight line shape which is not bent like the straight line L1, for example, a first connection line 170 (see FIG. 7) of the second example or a second connection line 180 (see FIG. 8).

Meanwhile, one or more intersecting portions A in which the plurality of straight lines L1, the plurality of bent lines L2, and the connection line L3 constituting the heating heater 100 intersect any one line at alternate angles are formed.

Accordingly, in the heating heater 100 applied to the hot water tank assembly 1 according to one embodiment of the present disclosure, a plurality of lines may be disposed in multiple rows, and the sizes of portions adjacent to and facing each other may be reduced. In addition, when purified water is heated and boiled to a high temperature, interference therebetween is minimal to reduce amounts of overheating and generated boiling bubbles.

Again, the first example of the heating heater 100 applied to the hot water tank assembly 1 according to one embodiment of the present disclosure will be specifically described below with reference to FIGS. 2 to 5.

As illustrated in the drawings, the heating heater 100 is disposed in multiple rows within the small width of the hot water tank 10 in the second direction, and as the first example, the heating heater 100 is disposed in a two-row shape within the width of the hot water tank 10 in the second direction.

In this case, the heating heater 100 is disposed in the accommodation space S of the hot water tank 10 as wide as possible to improve heating efficiency and prevent interference between the heater lines.

Specifically, the heating heater 100 according to the first example includes a first row heater line 110 connected to the first heating terminal part 20, a second row heater line 120 connected to the second heating terminal part 30, and a bent connection line 130.

First, the first row heater line 110 includes one or more straight lines L1 and one or more bent lines L2 and is connected to the first heating terminal part 20.

In addition, the second row heater line 120 includes one or more straight lines L1 and one or more bent lines L2, is connected to the second heating terminal part 30, and is disposed parallel to the first row heater line 110 in the accommodation space S of the hot water tank 10 in the second direction (Y-axis direction, or width direction).

In addition, the bent connection line 130 is the connection line L3, which connects the first row heater line 110 and the second row heater line 120 disposed in parallel to form a two-row structure, has the set R value, and is formed to be bent. Accordingly, start and finish portions of the bent connection line 130 are disposed in different rows.

More specifically, the heating heater 100 according to the first example will be described below.

First, referring to FIGS. 2 and 3 for convenience of description, a virtual dividing line C which divides the accommodation space S of the hot water tank 10 into a first space S1 disposed at a left side in the first direction (X-axis direction) and a second space S2 disposed at a right side in the first direction is formed.

In addition, referring to FIG. 3, the first row heater line 110 constituting the heating heater 100 of the first example includes a first straight line 111, a first bent line 112, and a second straight line 113.

In other words, the first row heater line 110 is formed of two straight lines L1 and one bent line L2.

Specifically, the first straight line 111 is formed of the straight line L1 which is connected to the first heating terminal part 20 and extends from the second space S2 to the first space S1.

In addition, the first bent line 112 is formed of the bent line L2 formed by bending the first straight line 111 downward to have the set R value in the third direction in the first space S1.

In addition, the second straight line 113 is formed of the straight line L1 formed by extending the first bent line 112 downward at an angle in the third direction from the first space S1 to the second space S2 and connected to a lower portion of the bent connection line 130 in the third direction.

Meanwhile, the second row heater line 120 constituting the heating heater 100 of the first example includes a third straight line 121, a second bent line 122, a fourth straight line 123, and an extension line 124.

In other words, the second row heater line 120 includes two straight lines L1 and one bent line L2 and includes an extension line 124 which may be bent or have a straight line shape as necessary.

Specifically, the third straight line 121 is formed of the straight line L1 formed by extending an upper portion of the bent connection line 130 from the second space S2 to the first space S1.

In this case, the third straight line 121 is disposed parallel to the first straight line 111 constituting the first row heater line 110 in the accommodation space S such that there is no portion in which the third straight line 121 overlaps or intersects the first straight line 111.

In addition, the second bent line 122 is formed of the bent line L2 formed by bending the third straight line 121 downward to have the set R value in the third direction in the first space S1.

In this case, a first intersecting portion A1 in which the second bent line 122 intersects the first row heater line 110 at an alternate angle is formed. Specifically, the first intersecting portion A1 in which one side of the second bent line 122 intersects the first bent line 112 constituting the first row heater line 110 at the alternate angle is formed.

In addition, the fourth straight line 123 is formed of the straight line L1 formed by extending the second bent line 122 upward at an angle in the third direction from the first space S1 to the second space S2.

In this case, a second intersecting portion A2 in which the fourth straight line 123 intersects the first row heater line 110 at an alternate angle is formed.

Specifically, the second intersecting portion A2 in which one side of the fourth straight line 123 intersects the second straight line 113 constituting the first row heater line 110 at the alternate angle is formed. In addition, a third intersecting portion A3 in which the fourth straight line 123 intersects the bent connection line 130 at an alternate angle is formed.

In addition, the extension line 124 has a structure connecting the fourth straight line 123 and the second heating terminal part 30.

Meanwhile, the first heating terminal part 20 and the second heating terminal part 30 are disposed on the same outer surface of the hot water tank 10 and have a gap therebetween. In the drawings, as an example, it is illustrated that the first heating terminal part 20 and the second heating terminal part 30 are disposed at a right side of the hot water tank 10 in the first direction, but are not limited thereto, and may be disposed at a lower side of the hot water tank 10 in the third direction as necessary.

In this case, when the second heating terminal part 30 is located at a portion straightly connected to the fourth straight line 123, the extension line 124 may have a shape in which the fourth straight line 123 extends to the second heating terminal part 30 in a shape of the same straight line L1.

However, when the second heating terminal part 30 is located at another location, the extension line 124 is bent to have the set R value as necessary and connects the fourth straight line 123 and the second heating terminal part 30.

In the drawings, as an example, the extension line 124 is connected to the second heating terminal part 30 after the fourth straight line 123 is bent several times to have the set R value in the second space S2. Specifically, the extension line 124 has a structure in which the fourth straight line 123 is bent in the third direction in the second space S2, straightly extends upward, is bent in the first direction, and is connected to the second heating terminal part 30.

In this case, the extension line 124 and the first row heater line 110 form a fourth intersecting portion A4. Specifically, the fourth intersecting portion A4 in which the extension line 124 intersects the first straight line 111 constituting the first row heater line 110 at an alternate angle is formed.

Meanwhile, in the above description, the first bent line 112 of the first row heater line 110, the second bent line 122 of the second row heater line 120, and the bent connection line 130 are bent to have the same set R value and form arcs having semicircular shapes.

In addition, a bent portion of the extension line 124 is also bent to have the same set R value, and the bent portion forms an arc having an ¼ circular shape.

As described above, in the heating heater 100 of the first example constituting the hot water tank assembly 1 according to one embodiment of the present disclosure, the first row heater line 110 and the second row heater line 120 are disposed in two rows in parallel in the accommodation space S of the hot water tank 10.

In this case, the first row heater line 110 and the second row heater line 120 has a structure having a portion in which the first row heater line 110 and the second row heater line 120 face and overlap each other is minimized and one or more intersecting portions A (A1 to A4) in which the first row heater line 110 intersects the second row heater line 120 at an alternate angle are formed, thereby reducing the generation of superheated steam and bubbles in the hot water tank 10 having a small width.

In addition, the first row heater line 110 and the second row heater line 120 are structured to be disposed in parallel and have a maximum gap therebetween so that the lines are not close to each other in the accommodation space S of the hot water tank 10, and thus purified water stored in the hot water tank 10 can be heated while in uniform contact with the heater lines 110 and 120 in multiple rows to improve heating efficiency and reduce the generation of boiling bubbles and superheated steam at the same time.

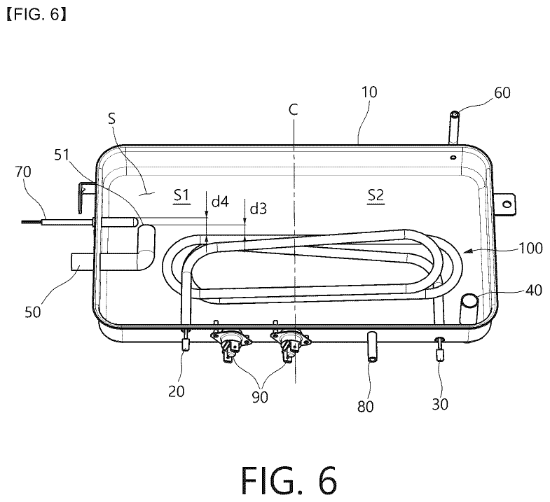

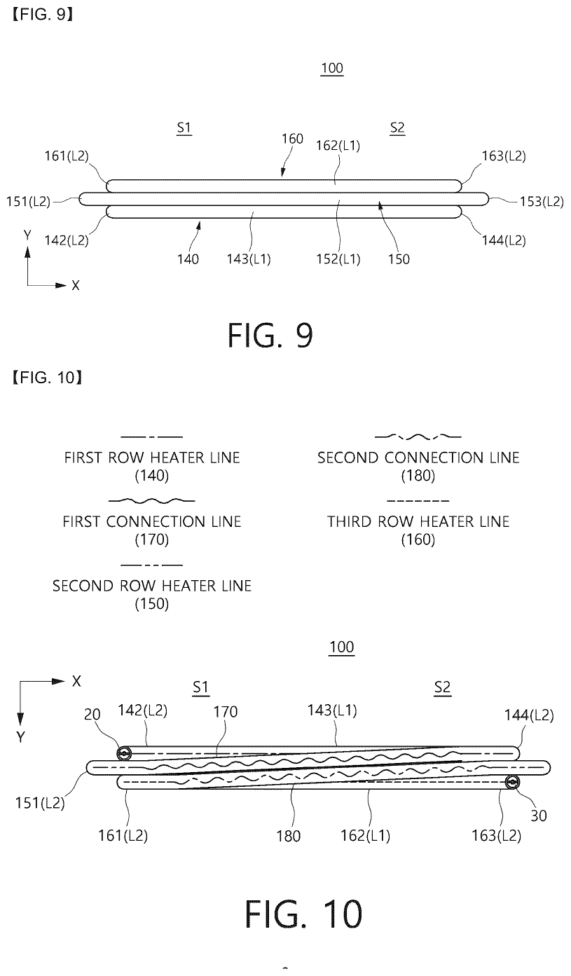

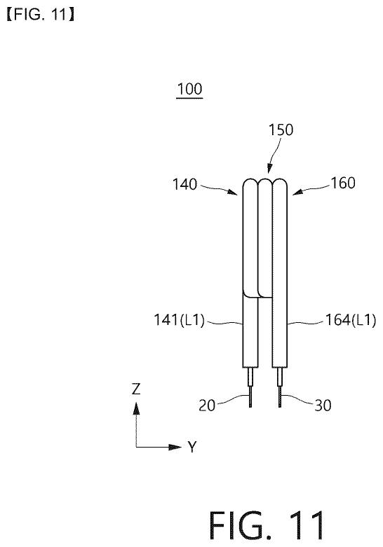

Meanwhile, FIG. 6 is a view illustrating a second example of the heating heater applied to the hot water tank assembly according to one embodiment of the present disclosure, and FIG. 7 is a view illustrating the heating heater of the second example according to FIG. 6 separated from the hot water tank in a second direction from one side. FIG. 8 is a view illustrating the heating heater of the second example according to FIG. 6 separated from the hot water tank in the second direction from the other side, and FIG. 9 is a top view illustrating the heating heater of the second example according to FIG. 7 in a third direction. FIG. 10 is a bottom view illustrating the heating heater of the second example according to FIG. 7 in the third direction, and FIG. 11 is a front view illustrating the heating heater of the second example according to FIG. 7 in the first direction.

A heating heater 100 applied to a hot water tank assembly 1 according to one embodiment of the present disclosure has a structure in which the size of a portion, in which heater lines 140, 150, and 160 in multiple rows face each other, is reduced and one or more intersecting portions A, in which the heater lines 140, 150, and 160 intersect at alternate angles, are formed.

Referring to FIGS. 1 and 6 to 11 again, as illustrated in the drawings, the heating heater 100 according to the second example is disposed in multiple rows within a small width of a hot water tank 10 in the second direction, that is, disposed in three rows within the width of the hot water tank 10 in the second direction.

In this case, the heating heater 100 is disposed as wide as possible in an accommodation space S of the hot water tank 10 to improve heating efficiency and also prevent interference therebetween.

Specifically, the heating heater 100 according to the second example includes a first′ row heater line 140 connected to a first heating terminal part 20, a third′ row heater line 160 connected to a second heating terminal part 30, a second′ row heater line 150 disposed in an intermediate row between the first′ row heater line 140 and the third′ row heater line 160, a first connection line 170, and a second connection line 180.

First, the first′ row heater line 140 includes one or more straight lines L1 and one or more bent lines L2 and is connected to the first heating terminal part 20.

In addition, the second′ row heater line 150 includes one or more straight lines L1 and one or more bent lines L2 and is disposed parallel to the first′ row heater line 140 in the accommodation space S.

Meanwhile, the third′ row heater line 160 is disposed parallel to the second′ row heater line 150, includes one or more straight lines L1 and one or more bent lines L2, and is connected to the second heating terminal part 30.

In addition, the first connection line 170 is formed of the straight line L1 connecting the first′ row heater line 140 and the second′ row heater line 150 and disposed in a first space S1 and a second space S2.

In addition, the second connection line 180 is formed of the straight line L1 connecting the second′ row heater line 150 and the third′ row heater line 160 and disposed in the first space S1 and the second space S2.

Preferably, the first connection line 170 and the second connection line 180 are each formed of the straight line L1 having a set length and are disposed in parallel.

As described above, the heating heater 100 according to the second example applied to the hot water tank assembly 1 according to one embodiment of the present disclosure is arranged to have an arrangement structure of three rows in the accommodation space S of the hot water tank 10.

Meanwhile, in the drawings, although it is illustrated that the first heating terminal part 20 and the second heating terminal part 30 are disposed on an outer lower side of the hot water tank 10 in the third direction to have a gap therebetween, but the first heating terminal part 20 and the second heating terminal part 30 are not limited thereto, and may also be disposed on a left or right side in the first direction as necessary.

First, referring to FIGS. 6 and 7 for convenience of description, a virtual dividing line C which divides the accommodation space S of the hot water tank 10 into the first space S1 disposed at a left side in the first direction (X-axis direction) and the second space S2 disposed at a right side in the first direction is formed.

In addition, referring to FIGS. 7 and 8, the first′ row heater line 140 constituting the heating heater 100 of the second example includes a first′ straight line 141, a first′ bent line 142, a second′ straight line 143, and a second′ bent line 144.

In other words, the first′ row heater line 140 is formed of two straight lines L1 and two bent lines L2.

Specifically, the first′ straight line 141 is formed of the straight line L1 of which one end portion is connected to the first heating terminal part 20 and which has a length extending upward in the third direction and is disposed in the first space S1.

In addition, the first′ bent line 142 is formed of the bent line L2 formed by bending the first′ straight line 141 to have a set R′ value to a right side in the first direction.

In addition, the second′ straight line 143 is formed of the straight line L1 formed by extending the first′ bent line 142 upward at an angle in the third direction from the first space S1 to the second space S2.

In addition, the second′ bent line 144 is formed of the bent line L2 formed by bending the second′ straight line 143 downward to have the set R′ value in the third direction in the second space S2 and connected to the first connection line 170 in a lower portion of the second space S2.

Meanwhile, referring to FIGS. 7 and 8 again, the second′ row heater line 150 constituting the heating heater 100 of the second example includes a third′ bent line 151, a third′ straight line 152, and a fourth′ bent line 153.

In other words, the second′ row heater line 150 is formed of one straight line L1 and two bent lines L2.

Specifically, the third′ bent line 151 is formed of the bent line L2 formed by bending the first connection line 170 upward to have the set R′ value in the third direction in the first space S1.

In this case, a first′ intersecting portion A′1 in which the third′ bent line 151 intersects the first′ row heater line 140 at an alternate angle is formed. Specifically, the first′ intersecting portion A′1 in which one side of the third′ bent line 151 intersects the first′ straight line 141 constituting the first′ row heater line 140 at the alternate angle is formed. In this case, the first′ intersecting portion A′1 may be a portion in which the third′ bent line 151 meets the first connection line 170.

In addition, the third′ straight line 152 is formed of the straight line L1 formed by extending the third′ bent line 151 from the first space S1 to the second space S2.

In this case, a second′ intersecting portion A′2 in which the third′ straight line 152 intersects the first′ row heater line 140 at an alternate angle in the second space S2 is formed. Specifically, the second′ intersecting portion A′2 may be formed by the third′ straight line 152 with the second′ straight line 143 or the second′ bent line 144 constituting the first′ row heater line 140.

In addition, the fourth′ bent line 153 is formed of the bent line L2 formed by bending the third′ straight line 152 downward to have the set R′ value in the third direction in the second space S2. In this case, the fourth′ bent line 153 is connected to the second connection line 180 (see FIG. 8) in the second space S2.

Meanwhile, referring to FIGS. 7 and 8 again, the third′ row heater line 160 constituting the heating heater 100 of the second example includes a fifth′ bent line 161, a fourth′ straight line 162, a sixth′ bent line 163, and a fifth′ straight line 164.

In other words, the third′ row heater line 160 is formed of two straight lines L1 and two bent lines L2 like the first′ row heater line 140.

Specifically, the fifth′ bent line 161 is formed of the bent line L2 formed by bending the second connection line 180 upward to have the set R′ value in the third direction in the first space S1.

In this case, a third′ intersecting portion A′3 in which the fifth′ bent line 161 intersects the first′ row heater line 140 at an alternate angle is formed, and a fourth′ intersecting portion A′4 in which the fifth′ bent line 161 intersects the second′ row heater line 150 at an alternate angle is formed.

Specifically, the third′ intersecting portion A′3 may be formed by the fifth′ bent line 161 with the first′ straight line 141 or the first′ bent line 142 constituting the first′ row heater line 140, and the fourth′ intersecting portion A′4 may be formed by the fifth′ bent line 161 with the third′ straight line 152 constituting the second′ row heater line 150.

In addition, the fourth′ straight line 162 is formed of the straight line L1 formed by extending the fifth′ bent line 161 downward at an angle in the third direction from first space S1 to the second space S2.

In this case, a fifth′ intersecting portion A′5 in which the fourth′ straight line 162 intersects the first′ row heater line 140 at an alternate angle is formed. Specifically, the fifth′ intersecting portion A′5 in which the fourth′ straight line 162 intersects the second′ straight line 143 constituting the first′ row heater line 140 at the alternate angle is formed.

Meanwhile, the sixth′ bent line 163 is formed of the bent line L2 formed by bending the fourth′ straight line 162 downward to have the set R′ value in the third direction in the second space S2.

In this case, a sixth′ intersecting portion A′6 in which the sixth′ bent line 163 intersects the first′ row heater line 140 at an alternate angle is formed. Specifically, the sixth′ intersecting portion A′6 in which the sixth′ bent line 163 intersects the second′ bent line 144 constituting the first′ row heater line 140 at the alternate angle is formed.

In addition, the fifth′ straight line 164 is formed of the straight line L1 formed by extending the sixth′ bent line 163 downward to have a length in the third direction in the second space S2 such that one end portion of the fifth′ straight line 164 is connected to the second heating terminal part 30.

In this case, a seventh′ intersecting portion A′7 in which the fifth′ straight line 164 intersects the second′ row heater line 150 at an alternate angle is formed. Specifically, the seventh′ intersecting portion A′7 in which the fifth′ straight line 164 intersects the fourth′ bent line 153 constituting the second′ row heater line 150 at the alternate angle is formed. In this case, the seventh′ intersecting portion A′7 may be a portion in which the fourth′ bent line 153 meets the second connection line 180.

Meanwhile, the first′ bent line 142 of the first′ row heater line 140 and the sixth′ bent line 163 of the third′ row heater line 160 which constitute the heating heater 100 of the second example are bent to have the same set R′ value, and preferably, may form arcs having ¼ circular shapes.

In addition, the second′ bent line 144 of the first′ row heater line 140, the third′ bent line 151 and the fourth′ bent line 153 of the second′ row heater line 150, and the fifth′ bent line 161 of the third′ row heater line 160 are bent to have the same set R′ value, and preferably, form arcs having semicircular shapes.

As described above, the heating heater 100 of the second example applied to the hot water tank assembly 1 according to one embodiment of the present disclosure has a structure in which the first′ row heater line 140, the second′ row heater line 150, and the third′ row heater line 160 are disposed in three rows in parallel in the accommodation space S of the hot water tank 10, a portion in which the first′ row heater line 140, the second′ row heater line 150, and the third′ row heater line 160 face and overlap each other is minimized, and one or more intersecting portions A (A′1 to A′7) in which the first′ row heater line 140, the second′ row heater line 150, and the third′ row heater line 160 intersect each other at the alternate angles are formed, and can reduce the generation of superheated steam and bubbles in the hot water tank 10 having the small width.

In addition, the first′ row heater line 140, the second′ row heater line 150, and the third′ row heater line 160 are structured to be disposed in parallel and have maximum gaps therebetween so that the lines are not close to each other in the accommodation space S of the hot water tank 10, and thus purified water stored in the hot water tank 10 can be heated while in uniform contact with the heater lines 140, 150, and 160 in multiple rows to improve heating efficiency and reduce generation of boiling bubbles and superheated steam at the same time.

Meanwhile, referring to FIGS. 3 and 7 to 8, in each of the heating heater 100 of the first example and the heating heater 100 of the second example applied to the hot water tank assembly 1 according to one embodiment of the present disclosure, bent line portions are bent to have the same bending value in each of the examples.

In other words, the heating heater 100 of the first example is bent to have the set R value, and the heating heater 100 of the second example is bent to have the set R′ value.

As described above, in the heating heater constituting one embodiment, when the heater lines in multiple rows are formed, since the heater lines are bent to have the same bending value, the heating heater 100 may be formed using one bending apparatus (not shown). Accordingly, the manufacturing of the heating heater 100 can be easy, and a manufacturing cost can be reduced.

As an example, the above-described set R value or R′ value (bending value) may be in the range of 20.5 mm to 22.5 mm in an arrangement structure of the heating heater 100 in multiple rows. However, the set R value or R′ value is not limited thereto, and may be changed as long as the heater lines are bent to have the same bending value.

Meanwhile, referring to FIGS. 2 and 6 again, as described above, the hot water tank assembly 1 according to one embodiment of the present disclosure includes a water inlet pipe 40, a water outlet pipe 50, an air-drain pipe 60, a temperature sensor 70, a drain pipe 80, and a bimetal 90 in the hot water tank 10.

In this case, in the water outlet pipe 50 included in the hot water tank 10, a water outlet port 51 is formed above an uppermost end portion, that is, a highest portion, of the heating heater 100. That is, as in FIG. 2, the water outlet port 51 is disposed above the heating heater 100 to have a gap d2 therebetween, or as in FIG. 6, the water outlet port 51 is disposed above the heating heater 100 to have a gap d3 therebetween.

Accordingly, the water outlet pipe 50 may stably discharge only high-temperature purified water heated by the heating heater 100 to the outside.

Meanwhile, preferably, the temperature sensor 70 is also provided to be disposed above the uppermost end portion, that is, the highest portion, of the heating heater. That is, as in FIG. 2, the temperature sensor 70 is disposed above the heating heater 100 to have a gap d1 therebetween, or as in FIG. 6, the temperature sensor 70 is disposed above the heating heater 100 to have a gap d4 therebetween.

Accordingly, the temperature sensor 70 may quickly measure a change in temperature of purified water according to operation of the heating heater 100 to prevent overheating which may occur in the accommodation space S of the hot water tank 10 in advance.

As described above, in the hot water tank assembly 1 according to one embodiment of the present disclosure, the intersecting portion A or A′ in which the heater lines of the heating heater 100 disposed in multiple rows and connected to the first heating terminal part 20 and the second heating terminal part 30 intersect at the alternate angles is formed to minimize surfaces facing each other in the heater lines.

Accordingly, the heating heater 100 can reduce amounts of generated bubbles and overheating.

In addition, the intersecting portion A or A′ is formed between the heater lines to reduce generation of superheated steam and prevent heat from being transferred to the purified water tank through a flow path, and thus a temperature increase of the purified water tank can be suppressed.

In addition, the heater lines of the heating heater 100 disposed in multiple rows are structured to be disposed in parallel and have a maximum gap therebetween so that the lines are not close to each other in the accommodation space S of the hot water tank 10, and thus purified water stored in the hot water tank 10 can be heated while in uniform contact with the heater lines in multiple rows to improve heating efficiency and reduce generation of boiling bubbles and superheated steam at the same time.

In addition, the heater lines disposed in multiple rows, since the bent lines L2 or the connection lines L3 are formed to have the same bending value in one embodiment, the manufacturing can be easy, and a manufacturing cost can be reduced.

In addition, an arrangement of forming the intersecting portion A or A′, in which portions of the heater lines disposed in multiple rows intersect, minimizes interference between the heater lines to reduce boiling sound when purified water is boiled.

According to the above configuration, in a hot water tank assembly according to the present disclosure, an intersecting portion, in which some portions of heater lines connecting a first heating terminal part and a second heating terminal part and disposed in multiple rows are disposed to intersect each other, is formed, thereby having effects of minimizing surfaces of the heater lines facing each other and reducing interference between the heater lines.

In addition, line portions in which heater lines face each other are minimized by forming an intersecting portion between the heater lines, thereby having an effect of reducing amounts of generated bubbles and overheating.

In addition, the generation of superheated steam is reduced and heat is not transferred into a purified water tank through a flow path by forming an intersecting portion between heater lines, thereby having an effect of suppressing a temperature increase in the purified water tank.

In addition, heater lines disposed in multiple rows are structured to be disposed in parallel and have a maximum gap therebetween so that the lines are not close to each other in an accommodation space of a hot water tank so that purified water stored in the hot water tank can be heated while in uniform contact with the heater lines in multiple rows, thereby having effects of improving heating efficiency and reducing the generation of boiling bubbles and superheated steam at the same time.

In addition, in heater lines disposed in multiple rows, bent lines each having a bending value of the same R value or connection lines are formed, thereby having an effect of facilitating manufacturing and reducing a manufacturing cost.

In addition, interference between heater lines is minimal due to an arrangement in which the intersecting portion, in which some portions of the heater lines disposed in multiple rows intersect each other, is formed, thereby having an effect of reducing sound when purified water is boiled in the accommodation space.

In addition, in a water outlet pipe, a water outlet port is formed above an uppermost end portion, that is, the highest portion, of a heating heater, thereby having an effect of stably discharging high-temperature purified water heated by the heating heater to the outside.

In addition, a temperature sensor is disposed above the uppermost end portion, that is, the highest portion, of the heating heater to quickly measure a change in temperature of purified water according to operation of the heating heater, thereby having an effect of preventing overheating which may occur in the accommodation space of the hot water tank.

Effects of the present disclosure are not limited to the above-described effects and should be understood to include all effects which may be inferred from the detailed description of the present disclosure or configuration of the present disclosure described in the claims.

While some embodiments of the present disclosure have been described above, the spirit of the present disclosure is not limited to the embodiments proposed in this specification, and other embodiments may be easily suggested by adding, changing, and removing components within the scope of the disclosure by those skilled in the art and will fall within the spiritual range of the present disclosure.

What is claimed is:

1. A hot water tank assembly comprising:
a hot water tank in which an accommodation space is formed to store purified water so that the purified water is introduced through a water inlet pipe and discharged through a water outlet pipe and which includes a first heating terminal part and a second heating terminal part at one side thereof; and
a heating heater connected to the first heating terminal part and the second heating terminal part and disposed in multiple rows in the accommodation space to heat the purified water,
wherein the heating heater includes a plurality of straight lines disposed in multiple rows in parallel in the accommodation space, a plurality of bent lines each having a set radius (R) value and connecting the straight lines disposed in the same row, and a connection line connecting the straight lines or the bent lines disposed in different rows, and
at least one intersecting portion, in which the straight line, the bent line, or the connection line intersects any one line of the straight line, the bent line, and the connection line, which are parallel and adjacent to each other, at an alternate angle, is formed.

2. The hot water tank assembly of claim 1, wherein the heating heater includes:
a first row heater line including at least one of the straight lines and at least one of the bent lines and connected to the first heating terminal part;
a second row heater line including at least one of the straight lines and at least one of the bent lines, connected to the second heating terminal part, and disposed parallel to the first row heater line; and
a bent connection line connecting the first row heater line and the second row heater line and formed to be bent at the set R value.

3. The hot water tank assembly of claim 2, wherein, based on a virtual dividing line which divides the accommodation space into a first space and a second space, the first row heater line includes:
a first straight line connected to the first heating terminal part and extending from the second space to the first space;
a first bent line formed by bending the first straight line to have the set R value in a third direction in the first space; and
a second straight line formed by extending the first bent line at an angle in the third direction from the first space to the second space and connected to the bent connection line.

4. The hot water tank assembly of claim 3, wherein the second row heater line includes:
a third straight line formed by extending the bent connection line from the second space to the first space to be parallel to the first straight line without overlapping or intersecting the first straight line;
a second bent line which is formed by bending the third straight line to have the set R value in the third direction in the first space and forms a first intersecting portion with the first row heater line;
a fourth straight line which is formed by extending the second bent line at an angle in the third direction from the first space to the second space, forms a second intersecting portion with the first row heater line, and forms a third intersecting portion with the bent connection line; and
an extension line connecting the fourth straight line and the second heating terminal part.

5. The hot water tank assembly of claim 4, wherein the extension line is formed by bending the fourth straight line several times to have the set R value, is connected to the second heating terminal part, and forms a fourth intersecting portion with the first row heater line.

6. The hot water tank assembly of claim 4, wherein each of the first bent line, the second bent line, and the bent connection line has the set R value and an arc having a semicircular shape.

7. The hot water tank assembly of claim 1, wherein the heating heater includes:
a first′ row heater line including at least one of the straight lines and the bent lines and connected to the first heating terminal part;
a second′ row heater line including at least one of the straight lines and the bent lines and disposed parallel to the first′ row heater line;
a third′ row heater line disposed parallel to the second′ row heater line, including at least one of the straight lines and the bent lines, and connected to the second heating terminal part;
a first connection line connecting the first′ row heater line and the second′ row heater line; and
a second connection line connecting the second′ row heater line and the third′ row heater line.

8. The hot water tank assembly of claim 7, wherein the first connection line and the second connection line include straight lines having set lengths and are disposed in parallel.

9. The hot water tank assembly of claim 7, wherein, based on a virtual dividing line which divides the accommodation space into a first space and a second space, the first′ row heater line includes:
a first′ straight line of which one end portion is connected to the first heating terminal part and which has a length in the third direction and is disposed in the first space;
a first′ bent line formed by bending the first′ straight line to have a set R′ value in a first direction;
a second′ straight line formed by extending the first′ bent line at an angle in the third direction from the first space to the second space; and
a second′ bent line formed by bending the second′ straight line to have the set R′ value in the third direction in the second space and connected to the first connection line in the second space.

10. The hot water tank assembly of claim 7, wherein the second′ row heater line includes:
a third′ bent line which is formed by bending the first connection line to have a set R′ value in the third direction in the first space and forms a first′ intersecting portion with the first′ row heater line;
a third′ straight line which is formed by extending the third′ bent line from the first space to the second space and forms a second′ intersecting portion with the first′ heater line; and
a fourth′ bent line formed by bending the third′ straight line to have the set R′ value in the third direction in the second space and connected to the second connection line in the second space.

11. The hot water tank assembly of claim 10, wherein the third′ row heater line includes:
a fifth′ bent line which is formed by bending the second connection line to have the set R′ value in the third direction in the first space, forms a third′ intersecting portion with the first′ row heater line, and forms a fourth′ intersecting portion with the second′ row heater line;
a fourth′ straight line which is formed by extending the fifth′ bent line at an angle in the third direction from the first space to the second space and forms a fifth′ intersecting portion with the first′ row heater line;
a sixth′ bent line which is formed by bending the fourth′ straight line to have the set R′ value in the third direction in the second space and forms a sixth′ intersecting portion with the first′ row heater line; and
a fifth′ straight line which is formed by extending the sixth′ bent line to have a length in the third direction in the second space such that one end portion of the fifth′ straight line is connected to the second heating terminal part, and forms a seventh′ intersecting portion with the second′ row heater line.

12. The hot water tank assembly of claim 11, wherein each of the first′ bent line and the sixth′ bent line has the set R′ value and forms an arc having a ¼ circular shape.

13. The hot water tank assembly of claim 11, wherein each of the second′ bent line, the third′ bent line, the fourth′ bent line, and the fifth′ bent line has the set R′ value and forms an arc having a semicircular shape.

14. The hot water tank assembly of claim 1, wherein the first heating terminal part and the second heating terminal part are disposed on the same outer surface of the hot water tank and have a gap therebetween.

15. The hot water tank assembly of claim 1, wherein, in the water outlet pipe,
a water outlet port is formed above a highest height of the heating heater.
